(19) United States
(12) Patent Application Publication
(10) Pub. No.: US 2025/0365069 A1
(43) Pub. Date: Nov. 27, 2025

(54) VISIBLE LIGHT COMMUNICATION SYSTEM AND METHOD THEREOF

(71) Applicant: The United States of America, as Represented by the Secretary of the Navy, Arlington, VA (US)

(72) Inventors: Don Edward Barber, JR., Pacific Grove, CA (US); Murali Tummala, Monterey, CA (US); John Colin McEachen, II, Carmel-by-the-Sea, CA (US)

(21) Appl. No.: 18/961,283

(22) Filed: Nov. 26, 2024

Related U.S. Application Data
(60) Provisional application No. 63/651,462, filed on May 24, 2024.

(51) Int. Cl. H04B 10/116; H04B 10/075

(52) U.S. Cl. CPC H04B 10/116; H04B 10/075

(57) ABSTRACT

A visible light communication apparatus comprising: sources configured to transmit a data signal; and a receiver comprising: measurement areas configured to sense and quantize energy from the sources, and attenuators configured to attenuate energy from the sources, by a step attenuation, based at least in part on a value of the sensed and quantized energy; the receiver being configured to determine whether the sensed and quantized energy saturated the measurement areas.

### CROSS-REFERENCE TO RELATED APPLICATIONS

This patent application is takes priority from U.S. Provisional Patent Application No. 63/651,462, filed on May 24, 2024, titled Improved Visible Light Communication System and Method Thereof, the contents of which are expressly incorporated herein by this reference as though set forth in their entirety and to which priority is claimed.

### STATEMENT OF GOVERNMENT INTEREST

The present disclosure was made in the performance of official duties by one or more employees of the Department of the Navy, and thus, embodiments herein may be manufactured, used or licensed by or for the Government of the United States of America for governmental purposes without the payment of any royalties thereon or therefor.

### FIELD OF USE

The present disclosure relates, in general, to a system and method of improving visible light communications. More specifically, the present disclosure relates to a method and system of improving the range and data rates of a visible light communications system using attenuation to improve quantization.

### BACKGROUND

Generally, visible light communication (VLC) is a wireless technology that uses visible light to transmit information. VLC systems typically use light-emitting diode (LED) transmitters to modulate the visible light used for illumination, which a photodetector or image sensor can receive. VLC systems can provide high-speed wireless data transmission and lighting simultaneously.

VLC systems may be used in advanced driver assistance systems (ADAS), such as those used in the automotive industry, to adapt or enhance vehicle systems to increase safety and provide better driving. In such systems, safety features are designed to avoid collisions and accidents by offering technologies that alert the driver to potential problems or to avoid collisions by implementing safeguards and taking over control of the vehicle.

Typically, VLC systems use photodetectors, image sensors, photodiodes, photoresistors, phototransistors, and photovoltaic light sensors. These light sensors have some disadvantages, such as short transmission coverage: VLC systems have traditionally been limited to a range of a few hundred meters, restricting them from long-distance communication. Objects may easily obstruct or block a VLC communication channel. Intense ambient light, such as bright light, can saturate VLC receivers. Interference from other light sources can reduce the quality and reliability of VLC signals. Optoelectronic errors such as LEDs, laser diodes, and photodetectors are sensitive to temperature changes and have a limited lifetime. Photodiodes have large detection areas but a limited spectral range. High dark currents and capacitance can also reduce signal quality.

Many of the VLC disadvantages relate to the quantization of visible light. The receiver's ability to process and decode is limited by the receiver's quantization of received signals. In many cases, but not all, vehicle lights are bright enough to saturate the receiver. In saturation, the signal is clipped to the maximum quantizer output values (255 for an 8-bit receiver), and any information above the cut-off threshold in the quantizer is lost. In other situations, where the ambient background is brighter than the received signal and the range of signal values that can be used on the quantizer is already limited and compressed as the camera scales quantization bin sizes to account for the range of brightness in the background scene.

The potential of VLC systems and intelligent transportation systems is currently limited by the range and data rates limited by the quantization characteristics of current receivers, sensors, and noisy environments. Therefore, what is needed is a method and system of quantizing received signals that improves the dynamic range of a signal and or a method that improves the signal to noise ratio of a detected signal.

### SUMMARY

To minimize the limitations in the prior art, and to minimize other limitations that will become apparent upon reading and understanding the present specification, the present disclosure discloses a new and useful system and method of improving visible light communications using attenuation to improve quantization.

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented herein below. It is to be understood that both the following general description and the following detailed description are exemplary and explanatory only and are not restrictive.

VLCs and intelligent transportation systems are range and data rate limited by the quantization characteristics of current receivers, sensors, and noisy environments. Therefore, a method and system of quantizing received signals is needed to improve the dynamic range of a signal and/or improve the signal-to-noise ratio of a detected signal.

Quantization in visible light communication receivers limits the possible digital outputs used to process and decode received signals. To improve range and data rates in visible light communication (VLC) systems, a receiver may dynamically adjust attenuation within the measurement area to improve the range and data rates of a VLC system.

One implementation of attenuation gain control in a receiver may include a dimmable filter, glass element, measurement area, and a gain exposure compensator. Attenuation may be dynamically inserted to control gain in a receiver. An electronically controlled dimmable filter may attenuate light before or after the initial optics to reduce incident photons or signal intensity. A photon-to-electric circuit may be used before quantization to correct for various issues, such as nonlinear distortion, input overload, and signal fading. A glass element may be used to focus or manipulate received images. A general-purpose processor, a digital signal processor (DSP), an application-specific integrated circuit (ASIC), or a field programmable gate array (FPGA) may be used to operate a dimmable filter, glass element, measurement area, and gain exposure compensator.

A visible light communication apparatus comprising: sources, wherein at least one source is configured to transmit a data signal; a receiver comprising: measurement areas configured to sense and quantize energy from the sources; and attenuators configured to attenuate energy from the sources, by a step attenuation, corresponding to a value of the sensed and quantized energy; and the receiver being configured to determine whether the sensed and quantized energy saturated the measurement areas. The receiver further configured to determine whether a saturated measurement area is due to the data signal or a noise source. Wherein the receiver is further configured to dynamically attenuate the sensed energy, based at least in part on the measurement areas being saturated by the noise source. Wherein the receiver is further configured to dynamically attenuate the data signal, based at least in part on the measurement areas being saturated by the data signal. Wherein the attenuators are added or stepped based at least in part on the value of the sensed and quantized energy of the sources. Wherein the attenuators are electronically controllable attenuators. Wherein the receiver is further configured to dynamically attenuate a saturated data signal, based at least in part on a signal to noise ratio and bit error rate. Wherein the measurement areas is a visible light sensor, the light sensor being selected from the group of light sensors consisting of one or more of: CMOS sensors, photodiodes, phototransistors, photomultipliers, photovoltaic cells, photoresistors, pin diodes, or CCD.

Another embodiment may be a vehicle comprising a visible light communication apparatus, wherein the visible light communication apparatus comprises: sources, wherein at least one source is configured to transmit a data signal; a receiver comprising: measurement areas configured to sense and quantize an energy from the sources, and attenuators configured to attenuate energy from the sources, by a step attenuation, corresponding to a value of the sensed and quantized energy; the receiver being configured to determine whether the sensed and quantized energy saturated the measurement areas; and the receiver further configured to determine whether a saturated measurement area is due to the data signal or a noise source. Wherein the receiver is further configured to dynamically attenuate the sensed energy, based at least in part on the measurement areas being saturated by the noise source. Wherein the receiver is further configured to dynamically attenuate the data signal, based at least in part on the measurement areas being saturated by the data signal. Wherein the attenuators are added or stepped based at least in part on the value of the sensed and quantized energy of the sources. Wherein the attenuators are electronically controllable step attenuators. Wherein the receiver is further configured to dynamically attenuate a saturated data signal, based at least in part on a signal to noise ratio and bit error rate. Wherein the measurement areas is a visible light sensor, the light sensor being selected from the group of light sensors consisting of CMOS sensors, photodiodes, phototransistors, photomultipliers, photovoltaic cells, photoresistors, pin diodes, or CCD.

Another embodiment may be a visible light communication apparatus, the apparatus comprising a non-transitory computer-readable medium storing instructions executable by a processor, wherein the instructions comprise instructions to increase a dynamic range of a receiver: Receiving a light energy from sources on measurement areas of the receiver, wherein at least sources transmits a data signal; locating measurement areas containing the data signal; quantizing the light energy of the measurement areas from the sources; identifying saturation of measurement areas; determining whether the saturation is caused by the data signal or a noise source; and adjusting an attenuation of the measurement areas, based at least in part on the saturation caused by the data signal or the noise source, wherein attenuation is increased until an acceptable signal to noise ratio is achieved. Wherein the attenuation adjustment is based at least in part on a signal to noise ratio and bit error rate. Wherein the attenuation is a stopping down speed. Wherein the attenuation is controlled by a photon to electric signal conversion of the one or measurement areas.

It is an object to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of one embodiment of a visible light communication (VLC) system.

FIG. 2 is an illustration of data signal clipping due to the quantization scale limits of a saturated signal.

FIG. 3 is an illustration of a data signal within the quantization scaling limits.

FIG. 4 is a process flow diagram of one embodiment of a data signal optimization attenuation algorithm.

FIG. 5 is an illustration of one implementation of attenuation gain control in a receiver.

FIG. 6 is an illustration of the path loss of light relative to a vehicle at a short distance and that of a vehicle relative to a longer distance.

### DETAILED DESCRIPTION OF THE ILLUSTRATIVE EMBODIMENTS

In the following detailed description of various embodiments of the present disclosure, numerous specific details are set forth in order to provide a thorough understanding of various aspects of one or more embodiments of the present disclosure. However, one or more embodiments of the present disclosure may be practiced without some or all of these specific details. In other instances, well-known methods, procedures, and/or components have not been described in detail so as not to unnecessarily obscure aspects of embodiments of the present disclosure.

While multiple embodiments are disclosed, still other embodiments of the devices, systems, and methods of the present disclosure will become apparent to those skilled in the art from the following detailed description, which shows and describes illustrative embodiments of the devices, systems, and methods of the present disclosure. As will be realized, the devices, systems, and methods of the present disclosure are capable of modifications in various obvious aspects, all without departing from the spirit and scope of the present disclosure. Accordingly, the screenshot figures, and the detailed descriptions thereof, are to be regarded as illustrative in nature and not restrictive. Also, the reference or non-reference to a particular embodiment of the devices, systems, and methods of the present disclosure shall not be interpreted to limit the scope of the present disclosure.

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers, or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-10% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

Furthermore, the one or more versions may be implemented as a method, apparatus, or article of manufacture using standard programming and/or engineering techniques to produce entirely hardware embodiment, an entirely software embodiment, or an embodiment combining software and hardware embodiments. Furthermore, the systems and methods may take the form of non-transitory computer readable media. More particularly, the present methods and systems may take the form of web-implemented computer software or a computer program product. Any suitable computer-readable storage medium may be utilized including, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick).

Those skilled in the art will recognize many modifications may be made to this configuration without departing from the scope of the disclosed embodiments.

Embodiments of the systems and methods are described below with reference to schematic diagrams, block diagrams, and flowchart illustrations of methods, systems, apparatuses and computer program products. It will be understood that each block of the block diagrams, schematic diagrams, and flowchart illustrations, and combinations of blocks in the block diagrams, schematic diagrams, and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

In the following description, certain terminology is used to describe certain features of the various embodiments of the device, method, and/or system. For example, as used herein, the terms “computer” and “computer system” generally refer to any device that processes information with an integrated circuit chip and/or central processing unit (CPU).

As used herein, the terms “software” and “application” refer to any set of machine-readable instructions on a machine, web interface, and/or computer system” that directs a computer's processor to perform specific steps, processes, or operations disclosed herein.

As used herein, the term “computer-readable medium” refers to any storage medium adapted to store data and/or instructions that are executable by a processor of a computer system. The computer-readable storage medium may be a computer-readable non-transitory storage medium and/or any non-transitory data storage circuitry (e.g., buggers, cache, and queues) within transceivers of transitory signals. The computer-readable storage medium may also be any tangible computer readable medium. In various embodiments, a computer readable storage medium may also be able to store data, which is able to be accessed by the processor of the computer system.

As used herein, the term “clipped” refers to when a signal is recorded by a sensor that has constraints on the range of data it can measure, it can occur when a signal is digitized, or it can occur any other time an analog or digital signal is transformed, particularly in the presence of gain or overshoot and undershoot.

As used herein, the term “granularity” refers to the degree to which a material or system is composed of distinguishable pieces.

As used herein, the term “line of sight” or “LOS” refers to an imaginary line between an observer and the target. It also refers to the direct path from a transmitter to the receiver and the obstructions that may fall in that path.

As used herein, the term “Lux” or “lx” refers to a unit of measurement for the intensity of light in the International System of Units (SI). It is defined as the amount of luminous flux, or visible light emitted, per unit area.

As used herein, the term “quantization” refers to the process of mapping continuous infinite values to smaller discrete finite values.

As used herein, the term “resolution” refers to the level of detail of a representation. Higher-resolution representations have more represented details per area of measurement, which results in a more detailed, smoother representation.

As used herein, the term “saturation” or “quantization pegged out” refers to the output of a circuit or a digital quantizer exceeding the possible range; the circuit or digital quantizer is said to be saturated and outputs its maximum possible value instead.

As used herein, the term “signal,” “energy signal,” or “data signal” refers to a form of transmission that conveys information between devices.

As used herein, the term “signal-to-noise ratio” refers to a measure used in science and engineering that compares the desired signal level to the background noise level.

As used herein, “signal to quantization noise ratio (SQNR)” refers to a quality measure describing the relationship between the maximum signal strength and the quantization error in analog-to-digital conversion.

As used herein, the term “visible light” refers to the part of the electromagnetic spectrum that humans can see having wavelengths from 380 to 750 nanometers.

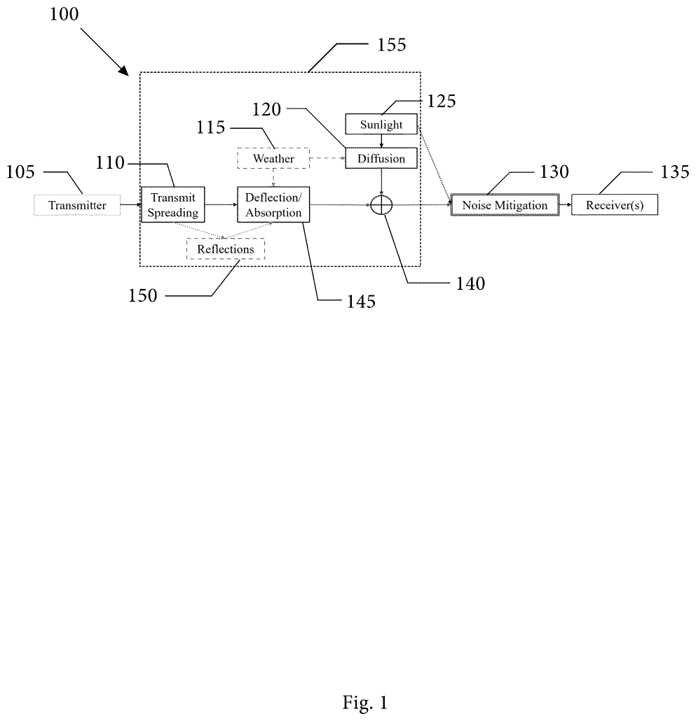

FIG. 1 is an illustration of one embodiment of a visible light communication (VLC) system. VLC communication system 100 may include transmitter 105, channel 155, and receiver 135.

VLC transmitter 105 may be but should not be limited to an electronic device that converts information (like sound, data, or video) into transmitted energy or a data signal that may be transmitted through channel 155, preferably taking a message and transforming it into a form suitable for transmission over a distance, typically using but not limited to radio waves, light pulses, or other electromagnetic signals; the primary function being to send information from one point to another. VLC transmitter 105 may utilize, but should not be limited, to light-emitting diodes (LEDs), Laser diodes, Fabry-Perot (F-P) lasers, distributed feedback (DFB) lasers, vertical-cavity surface-emitting lasers (VCSELs), and broadband light sources. LEDs may be cheaper and easier to use than laser diodes, but they have lower light power. Lasers may be able to transmit more light power than LEDs. Laser-based systems may be faster than LED-based systems. Broadband light sources emit light across a wide range of wavelengths and may typically be used to transmit large amounts of data. Transmitter 105 should preferably be able to modulate a light signal to represent different symbols. Modulation techniques typically vary the light signal's intensity around a positive DC value that provides lighting.

Communicating information signals across a distance typically propagates through some form of pathway or medium. These pathways, channel 155, may use a transmission medium such as a wire, waveguide, optical guide, free space, or a logical connection over a multiplexed medium such as a radio channel in telecommunications and computer networking. Channel 155 may be used for information transfer of a digital bit stream from one or several senders to one or several receivers. Channel 155 may have a certain capacity for transmitting information, often measured by its bandwidth in Hz or its data rate in bits per second. Channel 155 may also comprise sources of interference or noise such as but not limited to weather 115, transmit spreading 110, deflection absorption 145, reflections 150, sunlight 125, and diffusion 120. Sources of interference or noise energy may interfere with a receiver 135 or degrade the transmitted signal, which may increase error rates. Additional energy or light sources, such as but not limited to artificial light, sun, solar, or any other energy sources, may contribute to interference and noise.

Receiver 135 may be but should not be limited to an electronic device that receives or senses transmitted energy or data signals and converts and decodes the transmitted energy or data signal into a usable form, essentially translating the received data signal back into the original information intended by the sender, like sound, data, or video, that the intended recipient can understand.

In some instances, interference or noise such as but not limited to weather 115, transmit spreading 110, deflection absorption 145, reflections 150, sunlight 125, and diffusion 120 may degrade or interfere with receiver 125 ability to convert or decode a signal into usable form. Noise mitigations 130 may improve the ability of receiver 135 to convert or decode a signal and potentially improve rates and distances at which receiver 135 may operate reliably. Noise mitigations 130 may include but should not be limited to filtering, amplifying, attenuating, post-receiving signal processing, and data error correction.

Receiver 135 may also be limited by its ability to measure and quantify a received data signal. Such as but not limited to digital and analog data. Analog data that exceeds the maximum receiver 135 may sense and convert may be clipped or chopped at the maximum limit. This may lead to distortions in a converted signal. Digitized data quantization may limit the precision and detail of outputs and representations. For example, in commodity imaging hardware and software, 8 bits per channel per pixel is most common and provides images and video that appear natural to human perception. The 256 possible red, green, and blue values offer over 16.7 million colors. Each color may be represented by 256 digital levels, providing a finite and limited dynamic range for many signals. For example, 8-bit audio recordings may be distorted and unnatural. A typical background may contain 70,000 lux (lx) and attempting to represent a 70,000 lx illuminated scene with 256 levels, provided by 8 bits of resolution, each digital output value may represent an 8750 lx digital step. In many settings, a single 8750 lx single digital step may be well beyond the total dynamic range of the scene. The minimum required illumination for an office, established by the Occupational Health and Safety Administration, is only 300 lx. Both human vision and digital cameras adapt to account for such large ranges, enhancing sensitivity for dim objects in low light conditions and adjusting to expanding dynamic range in bright environments at the expense of subtle details in dark areas.

To accommodate the full dynamic range of a scene, quantization noise power, PQ is

$$PQ = \frac{max ( {P}_{amb} , {P}_{Rx} )}{3 \times {2}^{2 b}}$$

where the upper quantization value may be based on the greatest average brightness in a camera's field of view (FOV), this maximum brightness may not necessarily be the brightness of the received signal. If the signal is the brightest set of pixels, it drives the upper limit of the quantizer, and the maximum signal-to-quantization-noise ratio (SQNR) with 8 bits at 6 dB per bit in a uniform quantizer may be 48 dB. However, if a scene is brighter than the received transmission, the top quantization value may be based on scene brightness, not PRx. This effectively reduces SQNR, where SQNRcam is the SQNR the camera would have for the whole scene.

$$S Q N {R}_{signal} = {P}_{Rx} \times ( \frac{3 \times {2}^{2 b}}{{P}_{amb}} ) = S Q N {R}_{cam} \times ( \frac{{P}_{Rx}}{{P}_{amb}} )$$

If the signal dynamic range is half the scene dynamic range, only half the quantization bins are used. In an 8-bit quantizer with 256 levels, the signal only modulates across 128 levels. Effectively, the signal only has access to 7 bits of output resolution. Using the 6 dB per approximation, the best possible SQNR may now be limited to 42 dB, down from 48 dB, due to a brighter background expanding quantization bin size and reducing resolution. This may be one of the most significant challenges for outdoor VLC with commodity hardware. Modern CMOS sensors can detect low numbers of photons. Still, the only way to produce images with bright areas is to expand the upper quantization threshold, thus reducing the granularity of each digital increment and improving resolution. Daylight is a challenge not due to large random variations in noise power but because the background produces a large DC offset, reducing the output resolution of the sensor.

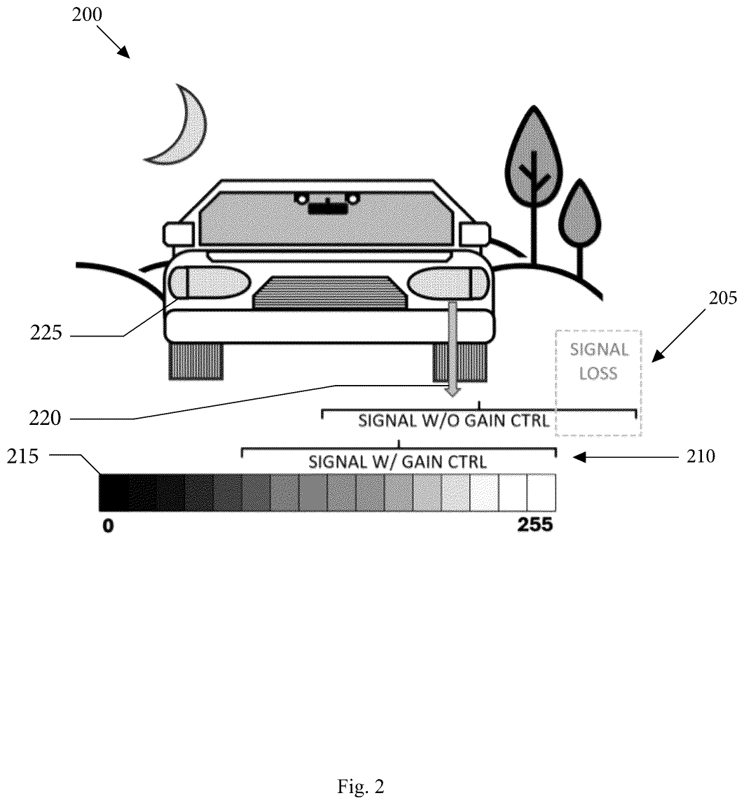

FIG. 2 is an illustration of data signal clipping due to the quantization scale limits of a saturated signal. Digital light sensors (not shown) typically convert analog physical data into discrete digital values; typical digital values range from 0-255 for an 8-bit system and 0-16,777,215 for a 24-bit system. The dynamic range of a sensor is the ratio of the largest measurable signal to the smallest measurable signal the sensor can accurately measure. A sensor that experiences a force greater than its dynamic range may be saturated and may typically be assigned the maximum digital value for any force greater than the sensor's maximum range.

FIG. 2 shows VLC system 200 as an 8-bit digital scale 215 represented by 256 steps. VLC system 200 may sense transmit signal 220 without gain control 205, and as shown in FIG. 2, a strong or intense transmit signal 220 may exceed the maximum the digital scale 215 may represent. Because signal 220 without gain control 205 exceeds the maximum digital scale 215 may represent, any excess information may be lost due to the truncation of the signal. However, if the entire scene is attenuated, as represented in the signal with gain control 210, the transmit signal 220 may be represented within the limits of digital scale 215. Although the actual signal-to-noise ratio (SNR) may not physically be improved, the SQNR of the VLC system 200 may be improved.

The light energy of VCL system 200 transmit signal 220, leveraging headlight 225, may typically be significantly greater or brighter than other lights in the scene. For example, vehicle headlight 225 or taillight may fill tens of pixels across an imaging sensor having over two million pixels. This represents one-thousandth of a percent of a total frame; vehicle light sources may not drive the peak quantizer value. This may lead to saturation, where the quantizer simply truncates and discards any overshot, outputting only the maximum value of the quantization bin, thereby reducing the dynamic range by the signal clipped and potentially lost. Attenuating the received signal may present a form of signal-reducing gain control and may increase the performance of visible light communication systems.

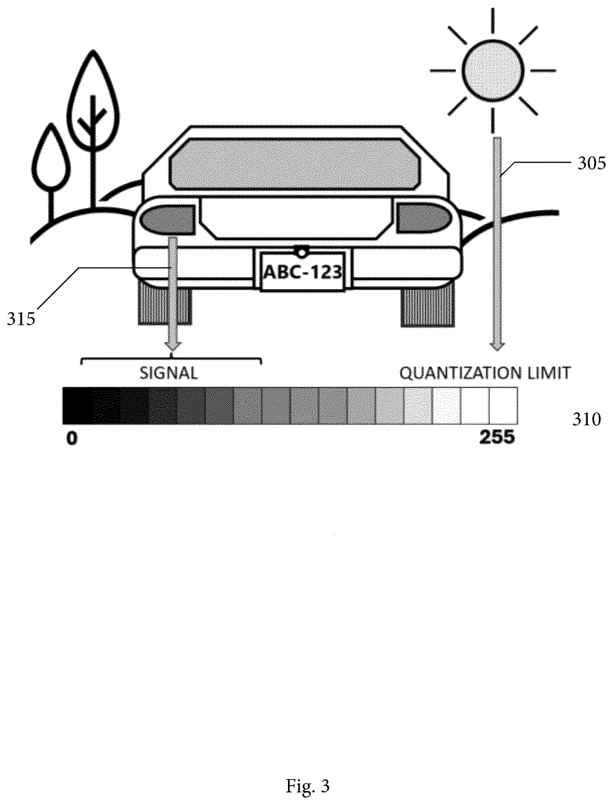

FIG. 3 is an illustration of a data signal within the quantization scaling limits. If the background 305 is brighter than the received signal 315 light of a VLC 300, the quantizer loses no signal to truncation. In this case, attenuating the received signal only reduces the received signal strength. Considering the negative effects of increasing bright background on quantization resolution, attenuation may be used to compress quantization bin sizes and reduce quantization noise in some cases. As shown in FIG. 2, signal pixels may be driven into saturation when a signal is significantly brighter than the background. For a VLC, the signal is constrained to a small portion of a sensor, and for a CMOS sensor, less than 40 pixels out of 2 million pixels may represent the signal—and the signal intensity may not dominate the overall average brightness across the sensor. Beyond only filling 0.002% of the sensor array, the signal may be modulated so its average intensity over time is less than its peak value. The upper quantization bound of a sensor may be based on peak average brightness, not the potentially very few bright points. Attenuation may dim the scene, reducing both signal and noise. Attenuation, by itself, may not improve SNR since both signal and noise are reduced in the same amount. However, the interaction of very bright signal pixels with the quantizer is nonlinear. Attenuation may draw the peak signal intensity closer to the upper quantization bound, allowing potentially lost signal energy from the upper bound truncation to be incorporated into the ratio. Attenuation may darken the background 305 and suppress noise. Attenuating the signal may increase its dynamic range on the quantizer, improving SQNR.

As shown in FIG. 3, background 305 is brighter than signal 315, and saturation is driven by background 305. This situation may benefit from attenuation where attenuation may be used to compress quantization bin sizes and reduce quantization noise.

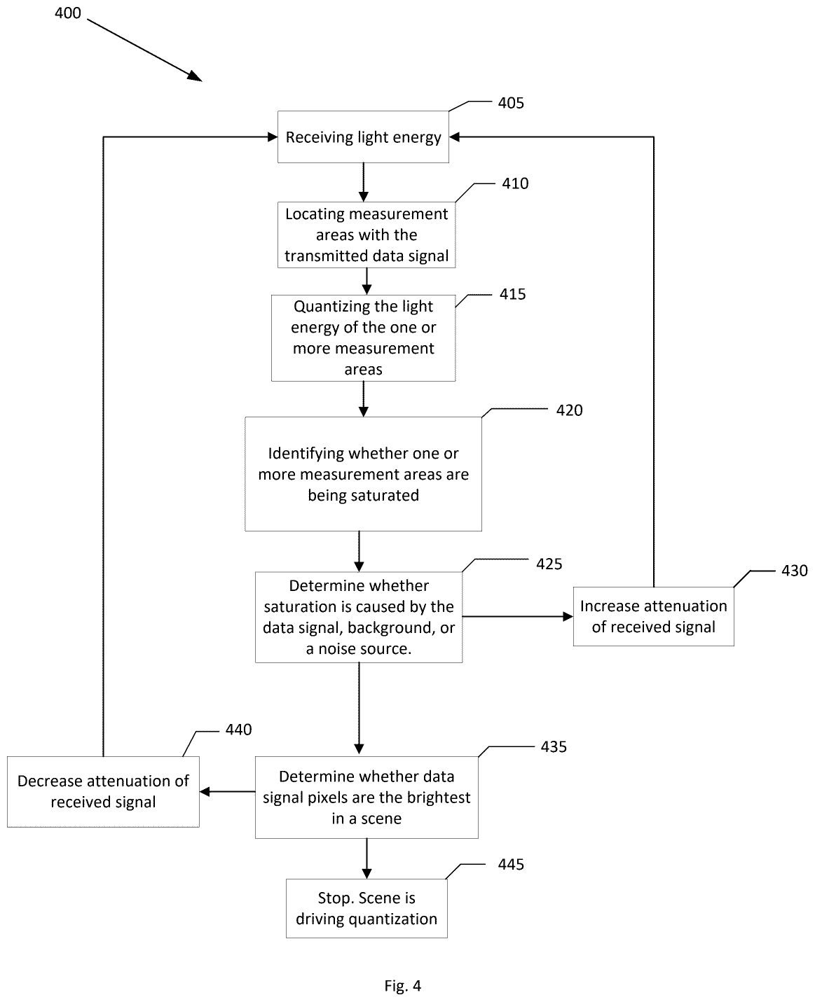

FIG. 4 is a process flow diagram of one embodiment of a data signal optimization attenuation algorithm. Attenuation optimization 400 may be performed by receiving 405 light energies from one or more sources on one or more measurement areas of the receiver. Measurement areas may be but should not be limited to individual or groups of pixels. Locating 410 measurement areas containing transmitted data signal(s). Locating 410 pixels may be achieved by filtering or sampling for specific preamble patterns in the scene. Locating 410 pixels containing signals may allow tuning to gain control at the receiver. Quantizing 415 is the conversion of measured energy of a measurement area to a digital represented value. Identifying 420 whether one or more measurement areas have been saturated or may be represented by the maximum quantizer value. Note: multiple signal pixels are at the maximum quantizer output, which may indicate saturation. Determining 425 whether the data signal, background, or noise source causes saturation of one or more measurement areas. If saturation is caused by background or a noise source, increase attenuation 430 of the received signal before quantization 415 until saturation is no longer experienced. If saturation is not caused by background or a noise source, determine 435 whether data signal measurement areas are the brightest in a scene. If data signals are the brightest in a scene, decrease attenuation 440 of the received signal. If the data signal is not the brightest in a scene, stop adjusting decrease attenuation 440. Processes 410, 415, 420,425, 430, 435, and 440 may be continuously iterated with variable attenuation step sizes depending on the application. Each separate application may be dependent on a trade-off between the granularity of a measured SNR optimization with the time and processing power needed to achieve further refinement or improvements in resolution. For example, applications requiring the highest possible SNR to minimize error, such as but not limited to long-distance communication, repeated iterations may allow for improved SNR with a trade-off of requiring multiple iterations of the optimization loop. At close ranges or when SNR may already be high, a simple coarse optimization provides improvement with minimal processing overhead.

If less than two pixels reach the maximum quantizer value, quantizer truncation may no longer be an issue, and no further attenuation may be needed.

Optionally, assessing whether the background is driving the upper quantization threshold or increasing gain by reducing attenuation could allow the signal to have a greater dynamic range. If the signal pixels are the brightest across the frame, attenuation may be reduced. Adjusting the brightest pixels toward the maximum quantizer value stretches the usable range, increasing the signal's dynamic range. The adaptive process may be stopped if the scene sets the upper quantization bound. Additional attenuation where the scene determines the maximum quantization may not produce additional gains.

Increase attenuation 430 and decrease attenuation 440 may be a function of SNR and bit error rate. A SNR may be lower if an acceptable bit error rate may be achieved. The coding scheme determines a code's tolerance for bit error rates (BER). A coding scheme with a low BER tolerance may require a higher SNR. A coding scheme with a high BER tolerance may allow for a lower SNR. Increase attenuation 430 and decrease attenuation 440 may be adjusted until the maximum transmission speed is reached while still operating within the tolerance of a coding scheme.

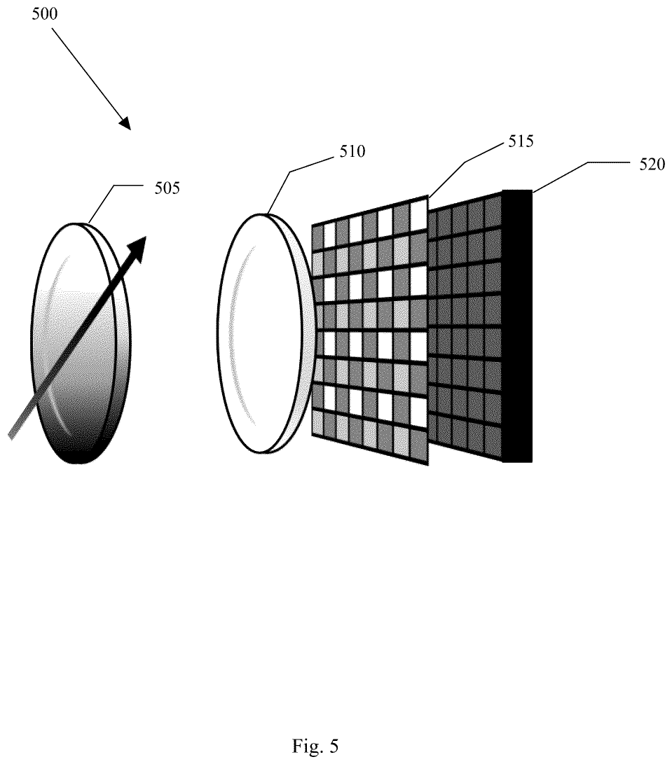

FIG. 5 is an illustration of one implementation of attenuation gain control in a receiver. Gain control 500 of a receiver may include dimmable filter 505, glass element 510, measurement area 515, and gain exposure 520 compensator.

Attenuation may be implemented using attenuation gain control in the receiver. Dimmable filter 505 may be an electronic dimmable filter, such as but not limited to a polymer dispersed liquid crystal (PDLC) film or polarizing filter. Dimmable filter 505 may attenuate light before or after the initial optics (not shown) to reduce incident photons or signal intensity.

Optical circuit compensation 520 circuits, photon-to-electric, may be used before quantization to correct for various issues, such as nonlinear distortion, input overload, and signal fading.

Glass element 510 may be used to focus or manipulate received images.

(Not shown) A general-purpose processor, a digital signal processor (DSP), an application-specific integrated circuit (ASIC), a field programmable gate array (FPGA) may be used to operate dimmable filter 505, glass element 510, measurement area 515, and gain exposure 520 compensator. Gain control 500 may store quantized values and parameters in system memory (not shown).

Gain exposure 520 may be incremental steps or a continuous analog attenuation.

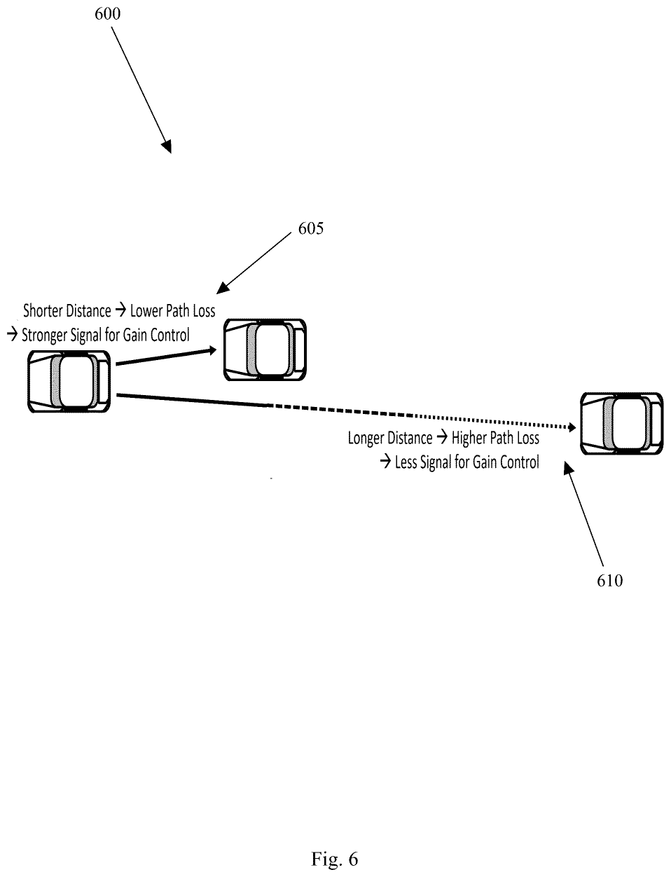

FIG. 6 is an illustration of the path loss of light relative to a vehicle at a short distance and that of a vehicle relative to a longer distance. In VLC 600, light from closer vehicle 605 may experience less path loss and spread, arriving with higher intensity at a receiver. The greater the intensity of the received signal, the more applicable attenuation of a signal may be to maximize the signal range of a VLC system. Conversely, farther away from vehicle 610, the received signal may be weaker due to channel interference. A weaker signal may require less attenuation to avoid quantizer truncation and loss of signal range.

Unless otherwise stated, all measurements, values, ratings, positions, magnitudes, sizes, locations, and other specifications that are set forth in this specification, including in the claims that follow, are approximate, not exact. They are intended to have a reasonable range that is consistent with the functions to which they relate and with what is customary in the art to which they pertain.

Some portions of the preceding detailed descriptions have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it should be appreciated that throughout the present disclosure, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display devices.

The processes or methods depicted in the figures may be performed by processing logic that comprises hardware (e.g., circuitry, dedicated logic, etc.), firmware, software (e.g., embodied on a non-transitory computer readable medium), or a combination thereof. Although the processes or methods are described above in terms of some sequential operations, it should be appreciated that some of the operations described may be performed in a different order. Moreover, some operations may be performed in parallel rather than sequentially.

In addition, the various illustrative logical blocks, modules, and circuits described in connection with certain embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, system-on-a-chip, or state machine. A processor may also be implemented as a combination of computing devices, e.g., a combination of a DSP and a microprocessor, a plurality of microprocessors, one or more microprocessors in conjunction with a DSP core, or any other such configuration.

Operational embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, a DVD disk, or any other form of storage medium known in the art. An exemplary storage medium is coupled to the processor such the processor may read information from, and write information to, the storage medium. In the alternative, the storage medium may be integral to the processor. The processor and the storage medium may reside in an ASIC or may reside as discrete components in another device.

Furthermore, the one or more versions may be implemented as a method, apparatus, or article of manufacture using standard programming and/or engineering techniques to produce software, firmware, hardware, or any combination thereof to control a computer to implement the disclosed embodiments. Non-transitory computer readable media may include but are not limited to magnetic storage devices (e.g., hard disk, floppy disk, magnetic strips), optical disks (e.g., compact disk (CD), digital versatile disk (DVD)), smart cards, and flash memory devices (e.g., card, stick). Those skilled in the art will recognize many modifications may be made to this configuration without departing from the scope of the disclosed embodiments.

The foregoing description of the preferred embodiment has been presented for the purposes of illustration and description. While multiple embodiments are disclosed, still other embodiments will become apparent to those skilled in the art from the above detailed description. These embodiments are capable of modifications in various obvious aspects, all without departing from the spirit and scope of protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. A visible light communication apparatus comprising:
one or more sources, wherein at least one source is configured to transmit a data signal;
a receiver comprising:
one or more measurement areas configured to sense and quantize energy from the one or more sources; and
one or more attenuators configured to attenuate energy from the one or more sources, by a step attenuation, corresponding to a value of the sensed and quantized energy; and
the receiver being configured to determine whether the sensed and quantized energy saturated the one or more measurement areas.

2. The apparatus of claim 1, the receiver further configured to determine whether a saturated one or more measurement area is due to the data signal or a noise source.

3. The apparatus of claim 2, wherein the receiver is further configured to dynamically attenuate the sensed energy, based at least in part on the one or more measurement areas being saturated by the noise source.

4. The apparatus of claim 2, wherein the receiver is further configured to dynamically attenuate the data signal, based at least in part on the one or more measurement areas being saturated by the data signal.

5. The apparatus of claim 1, wherein the one or more attenuators are added or stepped based at least in part on the value of the sensed and quantized energy of the one or more sources.

6. The apparatus of claim 1, wherein the one or more attenuators are electronically controllable attenuators.

7. The apparatus of claim 4, wherein the receiver is further configured to dynamically attenuate a saturated data signal, based at least in part on a signal to noise ratio and bit error rate.

8. The apparatus of claim 1, wherein the one or more measurement areas is a visible light sensor, the light sensor being selected from the group of light sensors consisting of one or more of: CMOS sensors, photodiodes, phototransistors, photomultipliers, photovoltaic cells, photoresistors, pin diodes, or CCD.

9. A vehicle comprising a visible light communication apparatus, wherein the visible light communication apparatus comprises:
one or more sources, wherein at least one source is configured to transmit a data signal;
a receiver comprising:
one or more measurement areas configured to sense and quantize an energy from the one or more sources, and
one or more attenuators configured to attenuate energy from the one or more sources, by a step attenuation, corresponding to a value of the sensed and quantized energy;
the receiver being configured to determine whether the sensed and quantized energy saturated the one or more measurement areas; and
the receiver further configured to determine whether a saturated one or more measurement area is due to the data signal or a noise source.

10. The apparatus of claim 9, wherein the receiver is further configured to dynamically attenuate the sensed energy, based at least in part on the one or more measurement areas being saturated by the noise source.

11. The apparatus of claim 9, wherein the receiver is further configured to dynamically attenuate the data signal, based at least in part on the one or more measurement areas being saturated by the data signal.

12. The apparatus of claim 9, wherein the one or more attenuators are added or stepped based at least in part on the value of the sensed and quantized energy of the one or more sources.

13. The apparatus of claim 9, wherein the one or more attenuators are electronically controllable step attenuators.

14. The apparatus of claim 12, wherein the receiver is further configured to dynamically attenuate a saturated data signal, based at least in part on a signal to noise ratio and bit error rate.

15. The apparatus of claim 9, wherein the one or more measurement areas is a visible light sensor, the light sensor being selected from the group of light sensors consisting of one or more of: CMOS sensors, photodiodes, phototransistors, photomultipliers, photovoltaic cells, photoresistors, pin diodes, or CCD.

16. A visible light communication apparatus, the apparatus comprising a non-transitory computer-readable medium storing instructions executable by a processor, wherein the instructions comprise instructions to increase a dynamic range of a receiver:
Receiving a light energy from one or more sources on one or more measurement areas of the receiver, wherein at least one or more sources transmits a data signal;
locating one or more measurement areas containing the data signal;
quantizing the light energy of the one or more measurement areas from the one or more sources;
identifying saturation of one or more measurement areas;
determining whether the saturation is caused by the data signal or a noise source; and
adjusting an attenuation of the one or more measurement areas, based at least in part on the saturation caused by the data signal or the noise source, wherein attenuation is increased until an acceptable signal to noise ratio is achieved.

17. The method of claim 16, wherein the attenuation adjustment is based at least in part on a signal to noise ratio and bit error rate.

18. The method of claim 16, wherein the attenuation is adjusted using a dimmable filter.

19. The method of claim 16, wherein the attenuation is a stopping down speed.

20. The method of claim 16, wherein the attenuation is controlled by a photon to electric signal conversion of the one or measurement areas.
